(19) United States
(12) Patent Application Publication
(10) Pub. No.: US 2009/0115156 A1
(43) Pub. Date: May 7, 2009

(54) METHOD OF MOUNTING AXLE MODULE

(76) Inventors: Shingo Tsujihama, Tokyo (JP); Hirohumi Okazaki, Tokyo (JP); Yoshio Banba, Tokyo (JP); Hitoshi Sasaki, Tokyo (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 11/572,022

(22) PCT Filed: Jul. 26, 2005
(86) PCT No.: PCT/JP2005/013648

§ 371 Date: Dec. 30, 2008

(30) Foreign Application Priority Data
Jul. 27, 2004 (JP) 2004-218974
Jul. 27, 2004 (JP) 2004-218984
Jul. 27, 2004 (JP) 2004-219017

(51) Int. Cl. B60G 11/113; B62D 65/12

(52) U.S. Cl. 280/124.175; 29/428

(57) ABSTRACT

An axle module is obtained by coupling an axle member and a pair of leaf springs in the same vertical relationship as in the actual state of use. At such time, when the axle member is disposed on a work stand, pins passing through holes provided in the right and left leaf springs for mounting to a vehicle body are inserted prior to tightening U-bolts used to mount the leaf springs. In addition, by applying a small force, the axle member can be moved in-plane within a predetermined range relative to the leaf springs. Furthermore, the tightening of nuts is carried out by moving tightening tools disposed on a carriage to a position underneath the tips of the U-bolts subject to tightening and then raising and rotating sockets installed in the tightening tools.

### TECHNICAL FIELD

The present invention is used at vehicle assembly plants. The present invention relates to a method of assembling axle modules, which are major automotive components, and to a device used in the process of their assembly. The present invention is used in the process of vehicle assembly, in particular, in the process of mounting leaf springs onto axle members.

The present invention represents one of the inventions incidental to the elimination of the cumbersome processes used in the past in the process of vehicle production, which involved inverting vehicle body frames with axle modules mounted onto them.

The present invention is related to prior applications (Patent document 1) by the present applicant. Although the present invention has been experimentally tested on work processes used in the embodiments disclosed in the prior applications, it is not limited to the operations disclosed in the prior applications and can be widely used in the process of vehicle production.

### BACKGROUND ART

Methods, in which working operations are performed after turning a vehicle body frame upside down, have been widely used in the past in the step of mounting an axle module onto a vehicle body frame. Namely, the process is set up to perform the mounting operation in a state, wherein a vehicle body frame is arranged in its work area in an inverted state (with the body-mounting side at the bottom) and an axle module, which is normally located at the bottom of a frame, is lowered from above the vehicle body frame and disposed onto the vehicle body frame. This is primarily due to the fact that when a vehicle body frame is in normal orientation (with the body-mounting side at the top and the axle-mounting side at the bottom), the distance between the vehicle body frame and the floor is reduced, which makes it more difficult for operators to access the bottom of the vehicle body frame. For this reason, in the past, vehicle assembly required an operation, wherein after attaching an axle module to a vehicle body frame, the vehicle body frame would be raised and rotated through 180 degrees about the longitudinal axis of the vehicle body frame with the help of large-scale equipment including cranes, after which the vehicle body frame would be lowered into work position.

Patent Document 1: JP2004-291954 A and WO2004/080785

Non-patent Document 1: “Jidousha gijutsu handobukku” (“Automotive Technology Handbook”), Vol. 4, Production-Quality-Maintenance, edited and published by the Society of Automotive Engineers of Japan, Sep. 1, 1991; in particular, see pp. 283-286.

### DISCLOSURE OF THE INVENTION

### Problems to be Solved by the Invention

For this reason, production facilities engaged in vehicle assembly require heavy-duty cranes or similar mechanical equipment in order to be able to lift entire vehicle body frames and turn them upside down while rigidly holding them in the air. In addition, the large-scale mechanical equipment used for this purpose must be designed to accommodate vehicles of the maximum dimensions that can be produced at the plant. Also, for this reason, an extremely large ceiling space is required for conventional vehicle assembly lines in order to fit the large-scale mechanical equipment in the air thereabove, which leads to an increase in the scale of the plant building itself.

Patent document 1 discloses a method and a device for assembling vehicles on a rotary assembly stand rather than by allowing vehicles subject to assembly to move along a rectilinear production line. Namely, it describes an operational arrangement, in which vehicles subject to assembly are disposed on a disk-shaped stand one by one (or several at a time) and assembly operations are carried out while slowly rotating the stand. The disk-shaped rotary assembly stand rotates, for example, once every several tens of minutes. During such time, modules necessary for vehicle assembly are continuously supplied from radially arranged peripheral staging areas towards the center of the rotary assembly stand. Then, just as one full turn of the rotary assembly stand is completed and the vehicle reaches a state where it is capable of self-propelled movement, a driver gets into the vehicle, starts the engine, and drives off the rotary assembly stand in self-propelled mode.

The term “module”, as used in this Specification, is a generic name for parts and materials supplied to the vehicle assembly process, including arrangements obtained by suitably assembling a plurality of components (e.g., engine modules, axle modules), individual components (e.g. wheels, batteries), as well as liquids, such as fuel, lubricating oils, etc.

It is understood that the use of the vehicle assembly process disclosed in Patent document 1 should permit a reduction in the scale of mass assembly plants and, at the same time, make it possible to reduce the number of work-in-process (WIP) components, permit a decrease in the time spent by the WIP components at the plant, and provide for savings in terms of automobile assembly-related interest rates. This new vehicle assembly process is particularly advantageous when the specifications of the assembled vehicles are non-uniform. In addition, it has been recognized that in this new vehicle assembly process, crane devices installed in the space above assembly work stations are limited to sufficiently simple equipment used for individual transportation of the required modules and that installation of large-scale equipment used for hoisting and inverting vehicle body frames is not suitable.

It is an object of the present invention to optimize the assembly of axle modules within the framework of technologies intended for simplifying the process of vehicle assembly and making it more economical by eliminating cumbersome steps involving inverting vehicle body frames having axle modules mounted thereto.

### Means for Solving the Problems

According to a first aspect of the present invention, there is provided a method of assembling an axle module by coupling an axle member and a pair of leaf springs, wherein the method of assembling an axle module comprises: a first step of disposing the axle member and the pair of leaf springs on a work stand in the same vertical relationship as in the actual state of use, a second step of placing U-bolts over the pair of leaf springs from above and slipping the tips of the U-bolts all the way through to the rear side of the axle member, and a third step of tightening nuts onto the tips of the U-bolts from below the axle member. Here, the expression “in the actual state of use” refers to a state, in which a module has been mounted onto a vehicle and made available for practical use.

In the above-described conventional work method, a vehicle body frame is, first of all, turned upside down, arranged in a working position, and an axle module is mounted on it, whereupon the entire vehicle body frame is turned over. Accordingly, the procedure used in the conventional axle module assembly step consisted in mounting leaf springs onto a vehicle body frame and then mounting the axle module. By contrast, in the present invention, axle modules are assembled in their normal orientation. Because the member located on top at such time is supplied later, the procedure involves (i) mounting leaf springs to an axle member and then (ii) mounting the leaf springs to a vehicle body frame.

It is believed that there is a chance that the arrangement used for mounting leaf springs to an axle member may not necessarily be optimal when mounting to a vehicle body frame in the subsequent step. For instance, there may be cases, in which (a) the two arc-shaped leaf springs do not lie in two mutually parallel planes. This is due to the fact that in this arrangement the leaf springs are attached in their central portions and the end portions of the leaf springs are free. Also, there may be cases, in which (b) the arrangement is such that the height of the distal ends of one of the leaf springs is different from the height of the distal ends of the other leaf spring, even though the two leaf springs lie in two mutually parallel planes.

These disadvantages did not exist in the operational sequence of the conventional work method, wherein leaf springs were first mounted to a vehicle body frame and an axle member was then fastened thereto using U-bolts.

The problems described in (a) or (b) above may arise in the step of fastening leaf springs to an axle member using U-bolts, or may arise in the stage when the unit is transported after tightening. It is believed that if the subsequent steps are carried out in such a state, then there is a chance that unexpected stresses may remain accumulated in the leaf springs or inside the axle member. Furthermore, the problems described in (a) or (b) above also depend on the level of skill and ability of operators and even highly capable operators require extra time to avoid such problems.

Therefore, it is desirable to use a plurality of mounting holes provided in the pair of leaf springs for mounting to a vehicle body frame and, prior to the third step described above, insert at least one pin passing through at least a pair of corresponding mounting holes in the pair of leaf springs in order to maintain the positional relationship of the pair of leaf springs. As a result, the pair of leaf springs remains parallel in the stage when the axle member is coupled to the pair of leaf springs and no particular strain is generated in the leaf springs as a result of coupling to the axle member. It should be noted that the expression “prior to the third step” may refer to the period when preliminary tightening of U-bolts has already been completed, but final tightening is yet to be performed.

Once the coupling of the axle member to the leaf springs is complete, the pins are removed from the axle module. After that, the pins are re-used. In other words, the pins are a type of tool and are not used as part of the product. The pins are of the ordinary kind. The pins are preferably made of metal. They may be bar- or tube-shaped. In addition, barriers preventing withdrawal can be provided on their ends.

In a construction, wherein a plurality of holes used for mounting to a vehicle body are provided in each leaf spring, it is desirable to insert a plurality of pins through the corresponding mounting holes in the leaf springs. Because in the most typical design there are two mounting holes provided in each leaf spring, two pins are passed therethrough for each one in order to keep them mutually parallel.

As far as the work stand is concerned, it is preferable to use a work stand whose construction supports the pins or leaf springs such that the plurality of pins remains parallel during the tightening of the U-bolts.

It is desirable to provide a period of time, during which the axle member can move in the horizontal direction (X-Y direction) on the work stand while maintaining its position in the vertical direction (height). The expression “to provide a period of time, during which the axle member can move in the horizontal direction” may refer to providing a period of time, during which movement in the horizontal direction is possible on a continuous basis, on an intermittent basis, on a temporary basis, on a repeated basis, or on a successive basis during the entire time.

The period of time, during which movement in the horizontal direction is possible, can be set to include a period of time for carrying out the first step. Such a configuration permits a dramatic reduction in the man-hours of labor because there is no need to perform alignment with high accuracy when placing the axle member on the work stand, e.g. when lowering the axle member onto the work stand with the help of a crane.

The period of time, during which movement in the horizontal direction is possible, can be set to include a period of time for carrying out the second step. The use of such a work procedure facilitates the insertion of the bolts and permits a reduction in the man-hours of labor because the horizontal movement of the axle member being fastened allows for the relative position of the U-bolts and leaf springs to be freely changed.

The period of time, during which movement in the horizontal direction is possible, can be set to include a period of time for carrying out the third step. As a result of such a set-up, even if unexpected situations arise where, for instance, unwanted stress is applied to certain members prior to tightening for one reason or another, stress is eliminated or dispersed naturally and does not linger in screws, nuts, or device components once the nuts are tightened because the relative position in the horizontal direction can be freely changed.

In the third step, it is desirable to move tightening tools disposed on a carriage to a position underneath the tips of the U-bolts and subsequently raise and rotate sockets installed in the tightening tools to tighten the nuts using a preset torque. The procedure can be set up so as to pre-tighten the nuts prior to performing tightening with the help of the tightening tools. For each leaf spring there is a pair of U-bolts, and the tightening of the plurality of nuts pre-tightened on their tips can be carried out in a concurrent manner.

Furthermore, this invention provides a semi-finished product manufactured in accordance with the above-described axle module assembly method, as well as a device used in the assembly method.

Namely, according to a second aspect of the present invention, there is provided an unfinished axle module product comprising an axle member, a pair of leaf springs respectively arranged perpendicular to the axial direction of the axle member, and a plurality of U-bolts fastening the pair of leaf springs to the axle member, wherein pins passing through the corresponding holes among the mounting holes provided in the pair of leaf springs for mounting to a vehicle body are inserted prior to mounting the axle module to a vehicle body.

According to a third aspect of the present invention, there is provided an axle module assembly device comprising a work stand, an axle member table provided on the work stand, and leaf spring supports provided on the work stand and supporting a pair of leaf springs above the axle member disposed on the axle member table such that their longitudinal direction is perpendicular to the axial direction of the axle member, with the axle member table including means enabling movement in the horizontal direction relative to the work stand.

Although the term “work stand” is used in singular form, a plurality of members may be combined into one work stand. Because in practical arrangements used at large-scale vehicle assembly plants a work stand would be too large to be made up of a single member and result in waste of material, a single work stand is formed by placing a plurality of separate members on a pedestal and interconnecting them using rigid members, etc. The expression “in the horizontal direction” refers to the direction of a straight line (the x direction) perpendicular to the direction of gravity (the z direction) or a plane (x, y) perpendicular to the direction of gravity. Despite the fact that the construction may become more complicated in terms of practical use, it is convenient to provide means enabling movement in-plane (x, y).

The movable means can be configured to include two plates arranged in parallel and multiple ball bearings sandwiched between the two plates. Furthermore, it can be constructed to comprise means for temporarily inhibiting the operation of the movable means and setting the axle member in the standard position (e.g. X=0, Y=0).

According to a fourth aspect of the present invention, there is provided an axle module assembly device comprising a carriage, a plurality of tightening tools disposed on the carriage with the respective sockets facing upwards and concurrently rotatably driven by power actuation, and movable means installed between the tightening tools and the carriage and used for adjusting the misalignment of the tips of the tightening tools.

It is preferable for the plurality of tightening tools to be mounted as a single unit. The unit preferably includes adjustment means for setting the relative position of the plurality of tightening tools in accordance with a plurality of specifications.

The plurality of tightening tools can be mounted as a single unit including, as the movable means, means enabling the unit to move in the horizontal direction and in the vertical direction. Bearing-floating means enabling the unit to move in the horizontal direction can be included in the movement enabling means. In addition, it can include hoisting means enabling the bearing floating means to move in the vertical direction relative to the carriage. Furthermore, it is desirable to provide a support structure supporting the unit at two points in a pivotable manner relative to the bearing-floating means.

### EFFECTS OF THE INVENTION

In the present invention, axle modules are assembled on a work stand in the same vertical relationship as in the actual state of use, i.e. in their normal orientation. Mounting a module on a vehicle body frame “as is”, in its normal orientation, eliminates the need to perform the operation of hoisting and inverting a vehicle body frame in the air after assembling an axle module, as was done when the conventional method or devices were used. This makes plant facilities very economical, e.g. reduces plant ceiling spaces, eliminates the need for heavy-duty equipment, etc.

In addition, by inserting pins into the mounting holes of the leaf springs in advance, the relative position of the axle member and leaf springs is stably maintained in the correct configuration during the tightening of the U-bolts, thereby eliminating unexpected stresses applied to certain portions of the axle module or leaf springs, etc. No stress is retained by any member after U-bolt tightening or after mounting to the vehicle body.

As a result of providing a period of time, during which movement in the horizontal direction is made possible, the need to perform accurate alignment when placing an axle member and leaf springs on a work stand is eliminated, the insertion of the bolts is facilitated, and the respective man-hours of labor can be reduced because the relative position of the U-bolts and leaf springs can be freely changed when the tips of the U-bolts are slipped through to the rear side of the axle member. In addition, even if unexpected situations arise where, for instance, unwanted stress is applied to certain members prior to fastening for one reason or another, the stress is eliminated or dispersed and does not linger in screws, nuts, or device components once the nuts are tightened because the relative position in the horizontal direction can be freely changed.

### BRIEF DESCRIPTION OF DRAWINGS

FIG. 1 is a perspective view explaining the work method and the construction of the device used therefore in an embodiment of the present invention.

FIG. 2 is a top view explaining positional relationships in an embodiment of the present invention.

FIG. 3 is a perspective partially cutaway view of a work stand.

FIG. 4 is a plan view of the main portion of a standard position setting mechanism.

FIG. 5 is a side view of the main portion of the standard position setting mechanism.

FIG. 6 is a perspective view explaining a construction, in which a work method used in an embodiment of the present invention is applied to a driving shaft member.

FIG. 7 is a top view explaining positional relationships in an embodiment of the present invention (in case of a driving shaft).

FIG. 8 is a perspective view providing an outline of the method and device used for tightening nuts on the tips of U-bolts at the rear side of an axle member.

FIG. 9 is a perspective view of a tightening apparatus.

FIG. 10 is a perspective view explaining a movable construction used for movement in the vertical direction.

FIG. 11 is a perspective view explaining a movable construction used for movement in the crosswise direction, as well as a movable construction used for engaging sockets with nuts.

FIG. 12 is a plan view explaining a construction used to accommodate leaf springs or U-bolts of various specifications.

FIG. 13 is a plan view showing an enlarged clearance between the sockets in FIG. 12.

### DESCRIPTION OF REFERENCE NUMERALS

1. Work stand.

2. Axle member table.

3. Leaf spring support.

4. Movable means.

5. Setting knob.

6. Pin.

7. Stopper.

8. Mounting hole.

11. Leaf spring.

12. U-bolt.

13. Axle member.

14. Nut.

15. Support.

16. Carriage.

17. Tightening tool.

18. Socket.

19. Unit.

20. Carriage.

21. Movable means.

22. Bottom plate.

23. Wall.

24. Up-and-down switch.

25. Battery.

26. Anchoring foot.

27. Bearing-floating means.

28. Base plate.

29. Handle.

30. Frame.

21. Axle.

32. Lever (for adjusting installation clearance).

33. Lever (for adjusting installation clearance).

34. Lever (for adjusting axle width).

35. Support plate.

36. Bottom plate.

37. Wall.

### BEST MODE FOR CARRYING OUT THE INVENTION

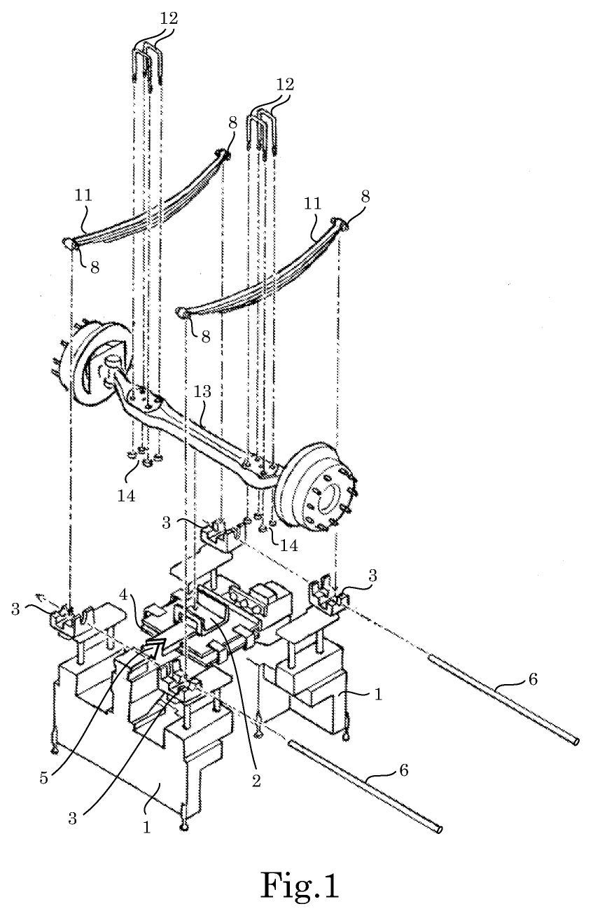

FIG. 1 is a perspective exploded view providing an outline of a work method and a device used therefore in an embodiment of the present invention. In this embodiment of the invention, axle member 13 and leaf springs 11 are disposed on work stand 1 in their normal orientation. In other words, they are disposed not in an inverted state, as was done conventionally under the commonly known work method, but in the same vertical direction as the vertical direction, in which they are arranged in a completely assembled vehicle. Furthermore, the pair of leaf springs 11 are also disposed on leaf spring supports 3 in normal orientation, in the direction perpendicular to axle member 13.

Here, two pins 6 are inserted into mounting holes 8 formed in the tips of two leaf springs 11. These two pins 6 have their tips fitted into cutouts in leaf spring supports 3 provided on work stand 1. As a result, the pair of leaf springs 11 is fixed in position and forms a regular quadrangle.

In addition, supports 3 have appropriate cutouts provided therein to allow for two pins 6 to be inserted along the paths shown by the dashed double dotted lines shown as their respective horizontal extensions.

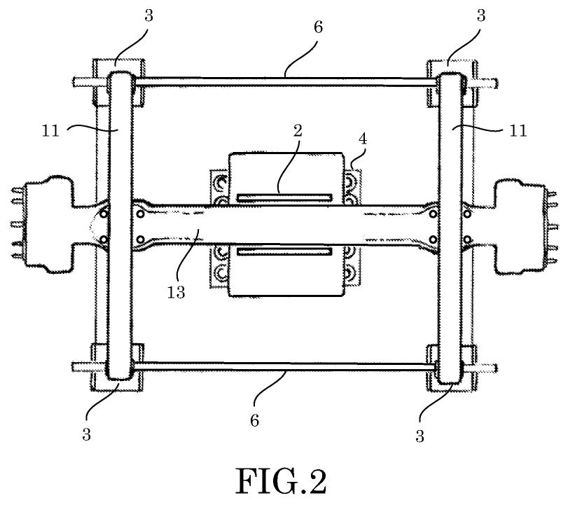

FIG. 2 is a top view. The top view of FIG. 2 shows a state, in which axle member 13 is disposed on the work stand, two leaf springs 11 are disposed on it from above, and, furthermore, pins 6, which are a characteristic feature of the invention, are inserted in the horizontal direction into mounting holes 8 of leaf springs 11. Axle member table 2, onto which axle member 13 is disposed, is adapted to be capable of movement in-plane within a predetermined range under the action of movable means 4. In this construction, the position of the U-bolt insertion holes provided in axle member 13 can be precisely adjusted to the position used for tightening leaf springs 11.

Now, going back to FIG. 1, a pair of U-bolts 12 is placed over leaf spring 11, which is one of the components installed in a vehicle subject to assembly. The tips of U-bolts 12 are then slipped through to the rear side of axle member 13. Nuts 14 are respectively fastened to the tips of U-bolts 12 on the rear side of axle member 13. While such fastening is performed, as well as during the period of time before and after it, two pins 6, which are the main constituent element of the present invention, act to maintain two leaf springs 11 in the correct configuration. Namely, as the tightening of U-bolts 12 proceeds, unnatural forces act neither on leaf springs 11, nor on axle member 13, and the tightening of U-bolts 12 is carried out such that two leaf springs 11 are maintained in the same configuration with respect to axle member 13 as the configuration used for mounting to a vehicle body in the subsequent steps.

Once the tightening of U-bolts 12 is complete, two pins 6 are removed from the axle module. Here, the term “axle module” refers to an arrangement, in which one axle member 13 and a pair of leaf springs 11 are fastened together using four U-bolts 12. Namely, two pins 6 are auxiliary tools used during assembly operations, which are removed from the axle module once its assembly is complete and re-used in subsequently performed similar operations in this step. These two pins 6 are made up of round metallic bars.

Now, brief explanations will be provided regarding work stand 1. When axle member 13 is disposed on axle member table 2 provided on work stand 1, axle member table 2 has movable means 4 provided therein, which allows for in-plane movement of the entire supported axle member 13 in the horizontal direction. Namely, as described above, two leaf springs 11 are disposed on, and secured to, two pairs of leaf spring supports 3, but the relative position of leaf springs 11 and axle member 13 can be changed in-plane because axle member table 2 is capable of in-plane movement.

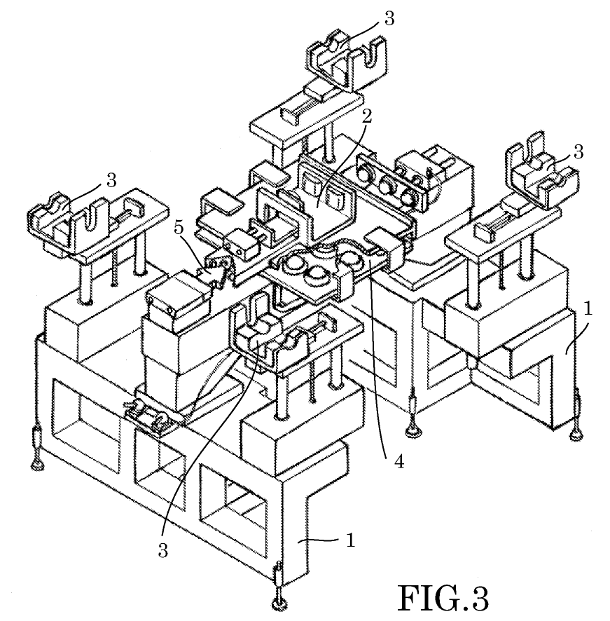

FIG. 3 is a perspective partially cutaway view of the work stand. The movable construction of axle member table 2 will be explained with reference to this figure. Axle member table 2 is mounted upon work stand 1 through the medium of movable means 4. Movable means 4 is an arrangement, wherein multiple ball bearings are sandwiched between two parallel plates, with the two parallel plates being capable of changing their relative position in-plane while maintaining parallel alignment. Of the two parallel plates, the lower plate is secured so as to maintain parallel alignment with work stand 1, in other words, perpendicular to the direction of gravity. Accordingly, the upper plate of the two parallel plates can be moved in co-planar fashion relative to work stand 1. Axle member 13 is a proportionately heavy component, but when the axle member is disposed on axle member table 2, operators can freely move it in the horizontal direction by gently nudging it with their hands. In the device of this embodiment, the range of movement allowed in the horizontal direction is between several centimeters and ten and several centimeters respectively in the X and Y directions.

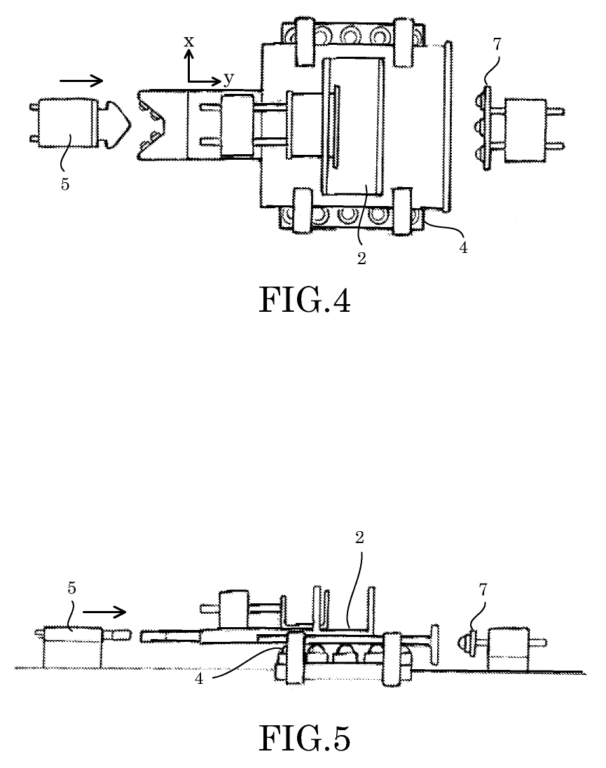

Next, explanations will be provided regarding the standard position setting mechanism. FIG. 4 is a plan view of the main portion of the standard position setting mechanism. Similarly, FIG. 5 is its side view. As explained above, axle member table 2 is adapted to freely change its in-plane position relative to the work stand under the action of movable means 4 comprising multiple ball bearings arranged in-plane. At the beginning of this step, when an axle member is disposed on axle member table 2, it is useful to put the table in a fixed position (X=0, Y=0). The standard position setting mechanism is provided for that particular purpose, with leaf spring supports 3 returning to the fixed position when setting knob 5 is pushed in the direction of the arrow by hand. In other words, when setting knob 5 is pushed in the direction of the arrow, the acute-angled portion of the tip of setting knob 5 is engaged with the cutout in axle member table 2 and its position in the x direction is corrected and set to zero (X=0). Furthermore, pushing setting knob 5 in the direction of the arrow brings the edge of axle member table 2 into contact with stopper 7 and its position in the y direction is set to zero (Y=0). As a result, whenever an axle member is put on the table, the above-described zero position setting is carried out immediately prior to the arrival of the axle member, which is lowered from above by a crane. Such operation permits effective use of the variable range of the standard position setting mechanism in the X direction and in the Y direction.

Although the movable constructions and standard position setting mechanism of axle member table 2 have been explained using examples involving assembly of axles for non-driven wheels, the same approach can be implemented in case of assembly of drive wheel axles. However, at the plant(s) of the applicant, the movable constructions and standard position setting mechanism have been practically tested only on axles used for non-driven wheels (which are normally the front wheels in freight vehicles). This is due to the fact that in case of axles used for drive wheels (for rear wheels) the shape of the axle member table is complicated by the differential gear cage, etc. with numerous protrusions and recesses, and, moreover, the shape varies depending on the type of the vehicle. On the other hand, using the complex irregular shape, accurate alignment can be relatively simply carried out using conventional centering technology.

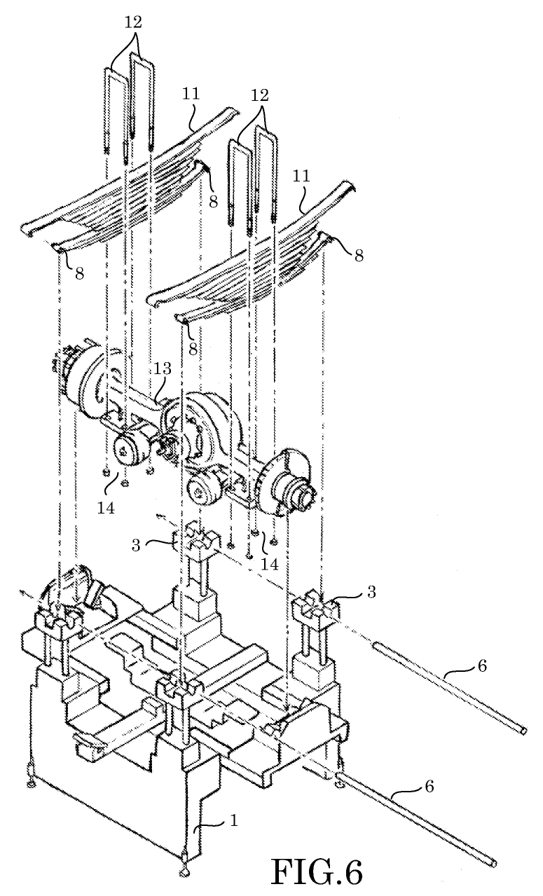

FIG. 6 is a perspective view of an axle member used for a driving shaft (rear wheels). In case of a driving shaft, leaf springs 11 are also mounted on both sides of axle member 13 using U-bolts 12. At such time, two pins 6 of the invention are inserted, respectively, into mounting holes 8 provided in the right and left leaf springs 11. As a result, the right and left leaf springs 11 are maintained in the intended design configuration with respect to axle member 13.

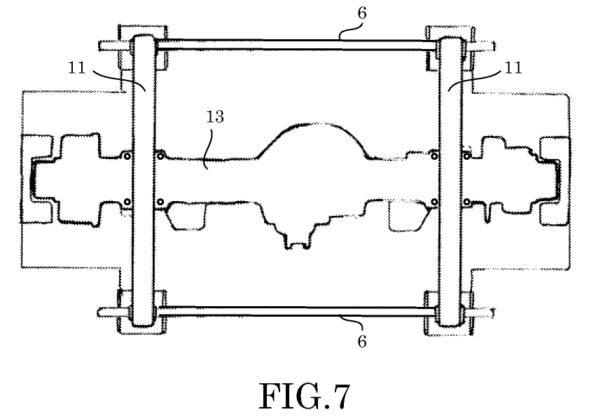

FIG. 7 illustrates a top view of drive wheels (rear wheels) disposed on a work stand. From the figure, one can understand positional relationships in the state wherein U-bolts are placed over the springs. In this case, too, inserting two pins 6 into holes provided in the ends of leaf springs 11 for mounting to a vehicle body allows for ensuring a stable state corresponding to being mounted onto a vehicle body. The U-bolts are tightened in this stable state. Accordingly, leaf springs 11 can be mounted onto axle member 13 without any unwanted stress being applied to leaf springs 11.

It should be noted that, as described above, axle member 13 for drive wheels has several irregular structures and these irregular structures can be used to firmly put axle member 13 in a fixed position on work stand 1. Accordingly, centering the table prior to placing the axle member thereon eliminates the need for the in-plane position adjustment mechanism formerly required in case of non-driven wheels. In the embodiments illustrated in FIG. 6 and FIG. 7, the in-plane movement-enabling mechanism used for centering is omitted.

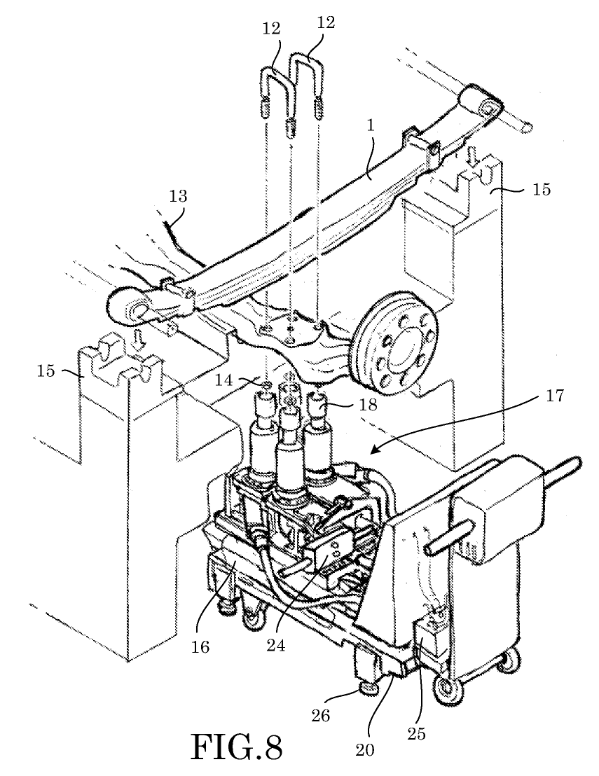

FIG. 8 is a perspective view providing an outline of the method and device used for tightening nuts on the tips of U-bolts at the rear side of an axle member. Namely, a pair of U-bolts 12 is placed over leaf spring 11, which is one of the components installed in a vehicle subject to assembly. The tips of U-bolts 12 are then slipped through to the rear side of axle member 13. Nuts 14 are respectively fastened to the tips of U-bolts 12 on the rear side of axle member 13. In this embodiment of the invention, axle member 13 and leaf springs 11 are disposed on support stands 15 in their normal orientation. In other words, they are positioned not in an inverted state, as was done conventionally under the commonly known work method, but in the same vertical direction as the vertical direction, in which they are arranged in an completely assembled vehicle. Then, the operator moves carriage 20 together with tightening tools 17 to a position underneath the tips of U-bolts 12 by pushing tightening tools 17 disposed on carriage 20 by hand. The operator moves it by walking on the floor.

After performing visual alignment, the operator actuates, more specifically, presses the top button of up-and-down switch 24 in order to raise sockets 18 installed in tightening tools 17 towards the tips of U-bolts 12. When sockets 18 installed in tightening tools 17 start rising, air pressure is supplied thereto and they automatically rotate. The tips of sockets 18 engage with nuts 14 to perform simultaneous tightening of the four nuts. After reaching a respective preset tightening torque, tightening tools 17 start idling. In this manner, the four nuts are simultaneously and concurrently tightened. The operator aurally determines that all four sockets 18 are idling and presses the lower button of up-and-down switch 24. By doing so, the supply of air pressure used for rotation is stopped and tightening tools 17 are slowly lowered.

It is desirable for four nuts 14 to be manually pre-fastened on the tips of the pair of U-bolts 12 in advance. In addition, the four nuts can be disposed inside sockets 18 in advance without pre-fastening.

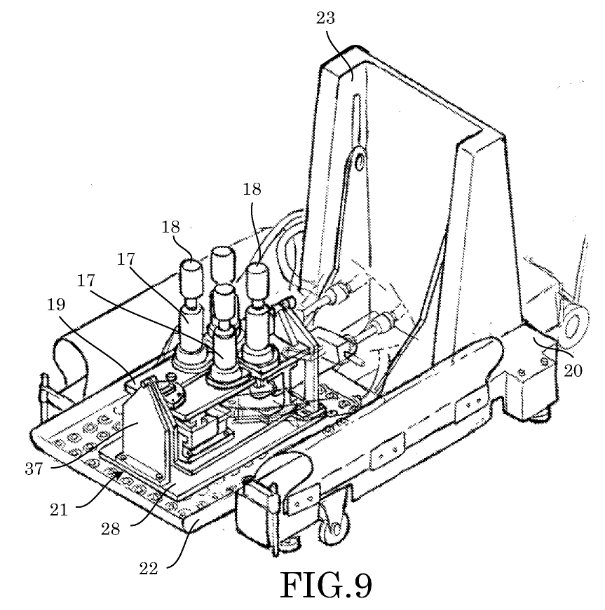

Now, detailed explanations will be provided regarding the construction of the tightening apparatus. FIG. 9 is a perspective view of the tightening apparatus. This apparatus comprises carriage 20, four tightening tools 17, which are disposed on carriage 20 with sockets 18 facing upwards and concurrently rotatably driven by power actuation (in this case, air pressure), and movable means 21, which is installed between tightening tools 17 and carriage 20 and is used for adjusting the misalignment of the tips of the tightening tools.

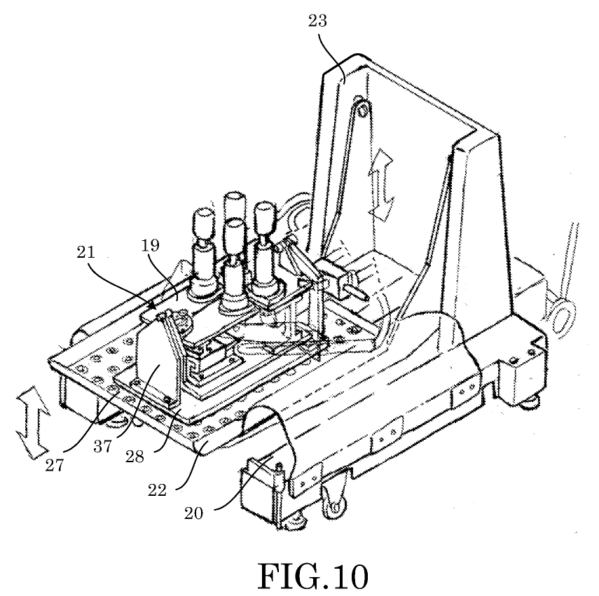

FIG. 10 is a perspective view explaining a movable construction for movement in the vertical direction forming part of movable means 21. Namely, horizontal platform 22, which is disposed on carriage 20, is formed so as to be movable in the vertical direction with respect to carriage 20, as shown by the arrow. To explain its construction more specifically, wall 23 with a nearly H-shaped cross-section is rigidly mounted to the frame of carriage 20 and bottom plate 22 (or platform) inside carriage 20 is mounted so as to be vertically movable over a distance of about 10 centimeters along wall 23. As a result, bottom plate 22 of carriage 20 can be moved up and down as shown by the two arrows in FIG. 10 while maintaining parallel alignment with the floor surface, on which carriage 20 is disposed. The hoisting mechanism, which enables the up-and-down movement of bottom plate 22 and is electrically powered, is provided inside wall 23, and, in particular, inside the two flanges of wall 23. The hoisting mechanism has the same construction as hoisting devices widely used for materials and equipment at plant work sites and explanations regarding its construction are therefore omitted.

The electrically powered hoisting mechanism is controlled by actuating up-and-down switch 24 seen in FIG. 8. When up-and-down switch 24 is actuated on the upper side (up), bottom plate 22 is raised as a result of electric current supply from battery 25 disposed on carriage 20. In addition, when switch 24 is actuated on the upper side (up), anchoring feet 26 provided on carriage 20 protrude towards the floor in concert with the ascent of bottom plate 22, thereby substantially disabling the wheels supporting carriage 20 and immobilizing the carriage on the floor. After that, bottom plate 22 is lowered into the initial position by actuating switch 24 on the lower side (down). At such time, anchoring feet 26 are simultaneously raised from the floor, the load is shifted to the wheels, and the wheels are again effectively engaged with the floor.

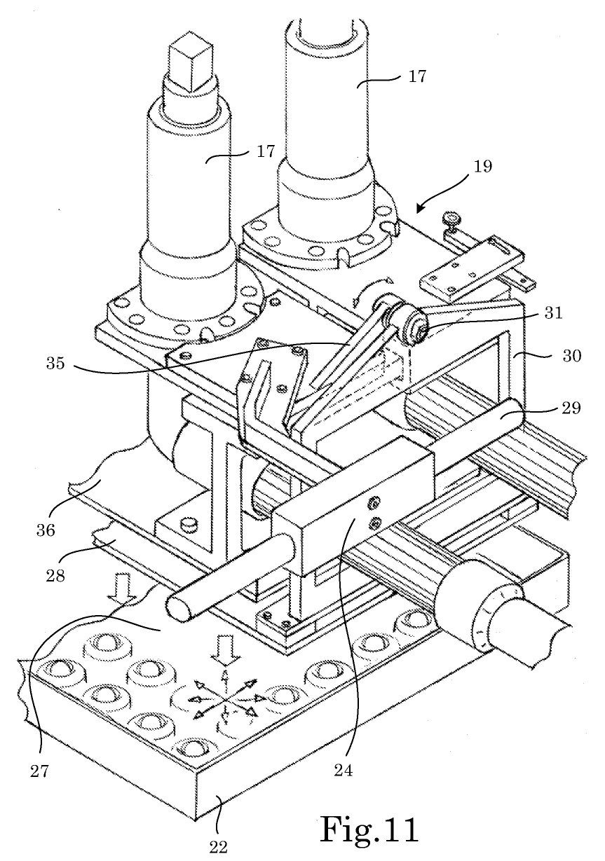

The electrically powered hoisting mechanism constitutes a movable construction used for movement in the vertical direction within movable means 21. Now, by referring to FIG. 11, detailed explanations will be provided regarding a movable construction used for efficiently engaging sockets 18 at the tips of tightening tools 17 with nuts 14, as well as regarding a movable construction used for movement in the horizontal direction within movable means 21.

FIG. 11 is a perspective view used to explain a construction obtained by combining bearing floating means 27 and a Japanese palanquin-shaped two-point support structure. Four tightening tools 17 are mounted as a single unit 19. In addition, the four tightening tools have their tips pointing in the vertical direction. Furthermore, the relative position of the four tightening tools precisely matches the relative position of the tips of the pair of U-bolts described above. As explained above, in an ideal situation, when bottom plate 22 is raised and lowered by actuating up-and-down switch 24, the tips of four tightening tools 17 are simultaneously engaged with nuts 14 that are to be tightened. The expression “in an ideal situation” refers to a situation, wherein the position in which the operator stops carriage 20 is extremely precise.

Because operators move carriage 20 across the floor by pushing it with their hand and visually determining an appropriate place for stopping carriage 20, when tightening tools 17 are raised, the position, in which carriage 20 is stopped, may not necessarily be the most appropriate position. This is the reason why the device of the present invention makes use of bearing floating means 27. Namely, multiple ball bearings are arranged in-plane in a matrix pattern on the upper surface of bottom plate 22 of carriage 20. On the other hand, the rear face of the base plate 28 of unit structure 19 is rendered flat and disposed such that the apexes of the multiple ball bearings arranged below come into contact therewith. As a result, practically uniform forces are applied to the ball bearings in the direction of the downward arrow in FIG. 11. Accordingly, as shown by the arrows pointing in the direction of plane 18 in FIG. 11, unit structure 19 can be freely moved in any direction by applying a small force. Namely, when one of tightening tools 17 is correctly engaged with a nut, tightening tools 17 are rotated in-plane about the engaged tightening tool 17 and engaged with other nuts.

Further explanations are provided with reference to FIG. 11. Frame 30 is secured to base plate 28. This frame 30 is pentagonal in shape and is supported for pivotal movement about shaft 31, which passes therethrough in the vicinity of its apex. Shaft 31 is secured to support plate 35, which is superimposed on frame 30, more precisely, slidably superimposed thereon in its top portion only. As a result, unit 19 is suspended from and held by this support plate 35. In the top left-hand corner of FIG. 11, there is provided pentagonal wall 37, not shown, which faces frame 30. Wall 37 is visible in FIG. 9 or FIG. 10. Going back to FIG. 11, unit 19 is suspended from shaft 31 and rocks about shaft 31 like a Japanese palanquin. Bottom plate 36 of this rocking cage is of a different construction than base plate 28, which is in contact with the above-described bearing floating means 27, and is configured by providing a gap between it and base plate 28, which is required for the rocking movement.

If proper engagement of all four tightening tools 17 with nuts is not achieved by bearing floating means 27 in the above-described manner, the operator gently touches handle 29. Handle 29 is secured to unit 19, to which the tightening tools are rigidly fixed. Impact from handle 29, causes unit 19, on which tightening tools 17 are disposed, to rock about shaft 21. Such action allows for two tightening tools 17 to be simultaneously engaged with nuts. If two tools are engaged, the other two tools can be engaged after that as well.

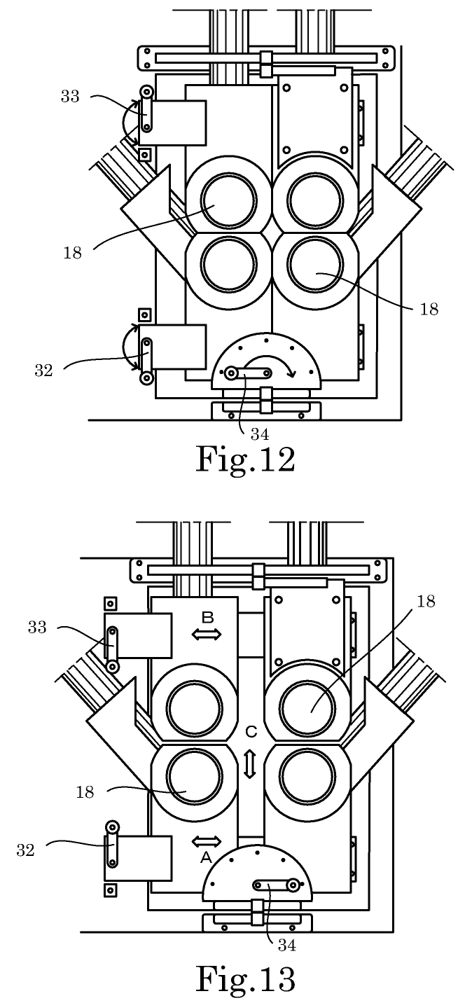

Next, by referring to FIG. 12 and FIG. 13, explanations are provided regarding a construction allowing a single device to accommodate leaf springs or U-bolts of various specifications. In other words, products processed in this step may use a plurality of specifications for U-bolts, as well as a plurality of specifications for clearances between two U-bolts. Accordingly, in order to be able to accommodate any specifications using a single inventive tool, a construction was chosen that permits adjustment of four axial widths (horizontal width in the drawings, corresponds to the width of the opening in the U-bolts) and four installation clearances (vertical width in the drawings, corresponds to the width, at which the two U-bolts are installed).

FIG. 12 and FIG. 13 illustrate plan views of the tightening tools. FIG. 12 corresponds to an arrangement having minimum axial width and installation clearance. FIG. 13 corresponds to an arrangement having maximum axial width and installation clearance described above. Namely, referring to FIG. 12, when lever 32 is actuated downward and lever 33 is actuated upward, the clearance between sockets 18 in the vertical direction, i.e. the installation clearance between two U-bolts, is minimized. Furthermore, if lever 34 is actuated to the left, the clearance between sockets 18 in the transverse direction, i.e. the axial width of a U-bolt, is minimized. If lever 32 is pulled up and lever 33 is pulled down, then the clearance between sockets 18 in the transverse direction is increased as shown by arrows A and B. If lever 34 is actuated to the right, the clearance between sockets 18 in the transverse direction is maximized. Actuating a combination of levers 32, 33 and 34 makes it possible to appropriately select the installation clearances of the two U-bolts and the specifications of the U-bolts.

It should be noted that, for ease of explanation, a coupling structure used for handle 29 was omitted in FIGS. 12 and 13.

### INDUSTRIAL APPLICABILITY

The method and device disclosed herein can be widely used and are not limited to processes utilizing rotary assembly stands, as described above. When implemented in conventional publicly known production lines, they can eliminate the need for large-scale equipment used for hoisting and inverting vehicle body frames.

1. A method of assembling an axle module by coupling an axle member and a pair of leaf springs, comprising:
a first step of disposing the axle member and the pair of leaf springs on a work stand in the same vertical relationship as in the actual state of use,
a second step of placing U-bolts over the pair of leaf springs from above and slipping the tips of the U-bolts all the way through to the rear side of the axle member, and
a third step of tightening nuts onto the tips of the U-bolts from below the axle member.

2. The method of assembling an axle module according to claim 1, wherein the pair of leaf springs is provided with a plurality of mounting holes used for mounting to a vehicle body frame and at least one pin passing through at least a pair of corresponding mounting holes in the pair of leaf springs is inserted in order to maintain the positional relationship of the pair of leaf springs prior to the third step.

3. The method of assembling an axle module according to claim 2, wherein a plurality of pins are inserted such that they pass through the corresponding mounting holes in the leaf springs.

4. The method of assembling an axle module according to claim 3, wherein a work stand having a construction supporting the pins or leaf springs such that the plurality of pins remain parallel during the tightening of the U-bolts is used as the work stand.

5. The method of assembling an axle module according to claim 1, wherein a period of time is provided which allows the axle member to move in the horizontal direction on the work stand while maintaining its position in the vertical direction.

6. The method of assembling an axle module according to claim 5, wherein the period of time, during which movement in the horizontal direction is possible, is a period of time that includes a period of time for carrying out the first step.

7. The method of assembling an axle module according to claim 5, wherein the period of time, during which movement in the horizontal direction is possible, is a period of time including a period of time for carrying out the second step.

8. The method of assembling an axle module according to claim 5, wherein the period of time, during which movement in the horizontal direction is possible, is a period of time including a period of time for carrying out the third step.

9. The method of assembling an axle module according to claim 1, wherein in the third step, tightening tools disposed on a carriage are moved to a position underneath the tips of the U-bolts, after which sockets installed in the tightening tools are raised and rotated to tighten the nuts using a preset torque.

10. The method of assembling an axle module according to claim 9, wherein a pair of U-bolts are provided for each leaf spring and the tightening of the plurality of nuts respectively pre-tightened on their tips is carried out in a concurrent manner.

11. An unfinished axle module product comprising an axle member, a pair of leaf springs arranged perpendicular to the axial direction of the axle member, and a plurality of U-bolts fastening the pair of leaf springs to the axle member,
wherein pins passing through the corresponding holes among the mounting holes provided in the pair of leaf springs for mounting to a vehicle body are inserted prior to mounting the axle module to a vehicle body.

12. An axle module assembly device comprising a work stand, an axle member table provided on the work stand, and leaf spring supports provided on the work stand and supporting a pair of leaf springs above the axle member disposed on the axle member table such that their longitudinal direction is perpendicular to the axial direction of the axle member,
wherein the axle member table includes means enabling movement in the horizontal direction relative to the work stand.

13. The axle module assembly device according to claim 12, wherein
the movable means includes two plates horizontally arranged and multiple ball bearings sandwiched between the two plates.

14. The axle module assembly device according to claim 12, comprising means for temporarily inhibiting the operation of the movable means and putting the axle member table in the standard position (X=0, Y=0).

15. An axle module assembly device comprising a carriage, a plurality of tightening tools disposed on the carriage with the respective sockets facing upwards and concurrently rotatably driven by power actuation, and movable means installed between the tightening tools and the carriage and used for adjusting the misalignment of the tips of the tightening tools.

16. The axle module assembly device according to claim 15, wherein the plurality of tightening tools are mounted as a single unit.

17. The axle module assembly device according to claim 16, wherein the unit comprises adjustment means for setting the relative position of the plurality of tightening tools in accordance with a plurality of specifications.

18. The axle module assembly device according to claim 15, wherein the plurality of tightening tools are mounted as a single unit, and
the axle module assembly device includes, as the movable means, means for enabling the unit to move in the horizontal direction and in the vertical direction.

19. The axle module assembly device according to claim 18, wherein
the movement enabling means includes bearing floating means enabling the unit to move in the horizontal direction.

20. The module assembly device according to claim 19, wherein
the movement enabling means include hoisting means enabling the bearing floating means to move in the vertical direction relative to the carriage.

21. The module assembly device according to claim 19, comprising a support structure supporting the unit at two points in a pivotable manner relative to the bearing-floating means.
